(19) United States
(12) Patent Application Publication
(10) Pub. No.: US 2015/0276650 A1
(43) Pub. Date: Oct. 1, 2015

(54) METHOD FOR FAST MEASUREMENT OF SPECIMEN CONCENTRATION

(71) Applicant: BROADMASTER BIOTECH CORP., Zhongli City (TW)

(72) Inventors: YI-LUNG CHEN, ZHONGLI CITY (TW); CHIEN-HUNG LAI, ZHONGLI CITY (TW); PO-HAO LIN, ZHONGLI CITY (TW); YA-SIAN LIN, ZHONGLI CITY (TW); YI-CHEN CHEN, ZHONGLI CITY (TW); FANG-YI JIANG, ZHONGLI CITY (TW); SHU-WEI YANG, ZHONGLI CITY (TW); YU-HSUAN TAI, ZHONGLI CITY (TW); SHIH-JEN LU, ZHONGLI CITY (TW)

(73) Assignee: BROADMASTER BIOTECH CORP., Zhongli City (TW)

(21) Appl. No.: 14/229,127

(22) Filed: Mar. 28, 2014

(51) Int. Cl. G01N 27/327

(52) U.S. Cl. CPC G01N 27/327

(57) ABSTRACT

A method for fast measurement of a specimen concentration which needs a sensing strip with an electrode test region on which an enzymatic reagent with a specific ingredient is coated and has steps as follows: place a specimen on the electrode test region of the sensing strip; apply a high voltage on the electrode test region for a period to create electrochemical current therein by which at least a faradic current and at least a non-faradic current are generated in the electrode test region; apply a measuring voltage less than the high voltage or the same as the high voltage on the electrode test region to generate a total current including faradic and non faradic currents and the total current finally reaching a steady current, which is measured for calculating a specimen concentration.

### BACKGROUND OF THE INVENTION

1. Field of the Invention

The present disclosure relates to a method for fast measurement of a specimen concentration, particularly a method accelerating equilibrium of chemical reactions.

2. Descriptions of the Related Art

The health of modern people with varied dietary habits and life styles has been widely influenced by chronic diseases, particularly high blood sugar, hypertension and hyperlipidemia, all of which are early signs of chronic diseases. Accordingly, how to measure physiological data routinely has become common sense of modern people.

As the major tool to measure physiological data currently, the electrochemical sensor system on the basis with an enzymatic amperometric method is used to test analytes in a specimen such as glucose level or cholesterol level. The electrochemical sensor system is based on the theory that an enzymatic reagent with a specific ingredient reacts with an analyte in a specimen, for example, glucose oxidase reacts with glucose in a specimen rather than other carbohydrates or cholesterol oxidase reacts with cholesterol in a specimen without interference of other substances. According to this characteristic, a measuring voltage is applied on the electrode to generate an electrochemical current (also known as Cottrell current) and calculate a concentration of the analyte in the specimen by referring to the Cottrell equation.

In the above descriptions, a sensing strip should be provided with an electrode test region consisting of two parallel electrodes (not shown in figures), i.e., a first conductive electrode and a second conductive electrode, on which an enzymatic reagent with a specific ingredient for development of chemical reactions between the enzymatic reagent and a specimen is coated. As shown in FIG. 3, a measuring voltage between 0.05V and 0.42V should be constantly applied for generation of electrochemical reactions (redox reactions) at the electrode test region in which an electrochemical current (also known as faradic current, F) is measured and taken as a basis to calculate a specimen concentration.

However, other substances held in an actual specimen such as uric acid or vitamin C contributes to a non-faradic current, N (as shown in FIG. 1), synchronously generated in redox reactions despite the above descriptions for a specimen concentration based on a faradic current, F, in a single redox reaction between the enzymatic reagent and the specimen on which a measuring voltage is applied. In general, a current meter takes more time (e.g., six seconds in many cases as shown in FIG. 2), to complete a test for measurement of a steady current when the total current T include a non-faradic current (N) equal to zero and a faradic current (F).

Accordingly, how to effectively reduce time in measuring a specimen concentration deserves to be studied by the persons skilled in the art.

### SUMMARY OF THE INVENTION

The present disclosure presents a method for fast measurement of a specimen concentration in a short time. The method needs a sensing strip with an electrode test region on which an enzymatic reagent with a specific ingredient is coated and comprises steps as follows:

Step 1: Place a specimen on the electrode test region of the sensing strip;

Step 2: Apply a high voltage on the electrode test region for a period in order to accelerate equilibrium of a non-faradic current;

Step 3: Apply a measuring voltage less than the high voltage or the same as the high voltage in Step 2 on the electrode test region to generate an electrochemical current finally reaching a steady current, which implies electrochemical current equilibrated with the non-faradic current disappearing, and measure the steady current for calculating a specimen concentration.

In the present disclosure, the high voltage in Step 2 is kept between the lowest potential to create redox reaction on the specimen and 5 Volt.

In the present disclosure, the high voltage in Step 2 is applied for 0.01 second to 1 second.

In the present disclosure, the measuring voltage in Step 3 is kept between 0.05 Volt and 0.42 Volt (oxidation voltage).

In the present disclosure, a total current including faradic and non-faradic currents generated on the electrode test region reaches a steady current in a short time to reach a steady current, the short time is 3 seconds or below 3 seconds.

In the present disclosure, the specimen can be glucose (blood sugar), uric acid or cholesterol so that an enzymatic reagent coated on the electrode test region has a distinct ingredient.

The present disclosure is beneficial to measurement of a specimen concentration completed in a short time by means of a high voltage applied for fast equilibrium of electrochemical current and consuming of any reaction with non-faradic current.

### BRIEF DESCRIPTION OF THE DRAWINGS

FIG. 1 is a graph of a faradic current and a non-faradic current versus time in a conventional method.

FIG. 2 is a graph of a total current including faradic and non-faradic current versus time in a conventional method.

FIG. 3 is a graph of a voltage applied versus time in a conventional method.

FIG. 4 is a flow diagram for the present disclosure of a method for fast measurement of a specimen concentration.

FIG. 5 is a graph of voltages applied versus time in the present disclosure of a method for fast measurement of a specimen concentration.

FIG. 6 is a graph of a faradic current and a non-faradic current versus time in the present disclosure of a method for fast measurement of a specimen concentration.

FIG. 7 is a graph of a total current including faradic and non-faradic current versus time in the present disclosure of a method for fast measurement of a specimen concentration.

FIG. 8A illustrates the present disclosure of a method for fast measurement of a specimen concentration and a conventional method, each of which lists data including mean currents, standard deviations and variances for measurement completed at T=0.5 sec.

FIG. 8B illustrates the present disclosure of a method for fast measurement of a specimen concentration and a conventional method, each of which lists data including mean currents, standard deviations and variances for measurement completed at T=1.0 sec.

FIG. 8C illustrates the present disclosure of a method for fast measurement of a specimen concentration and a conventional method, each of which lists data including mean currents, standard deviations and variances for measurement completed at T=2.0 sec.

FIG. 8D illustrates the present disclosure of a method for fast measurement of a specimen concentration and a conventional method, each of which lists data including mean currents, standard deviations and variances for measurement at completed T=3.0 sec.

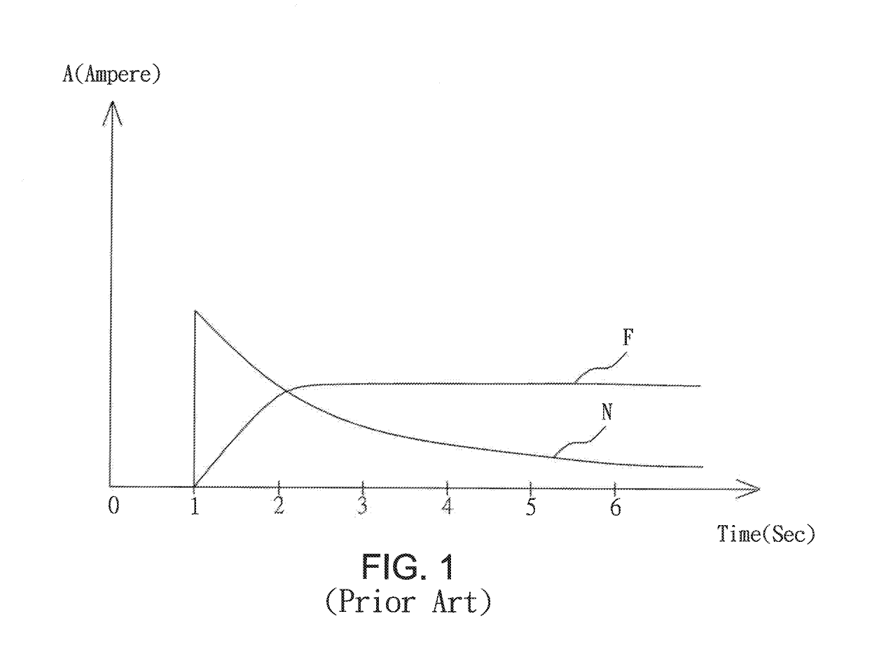

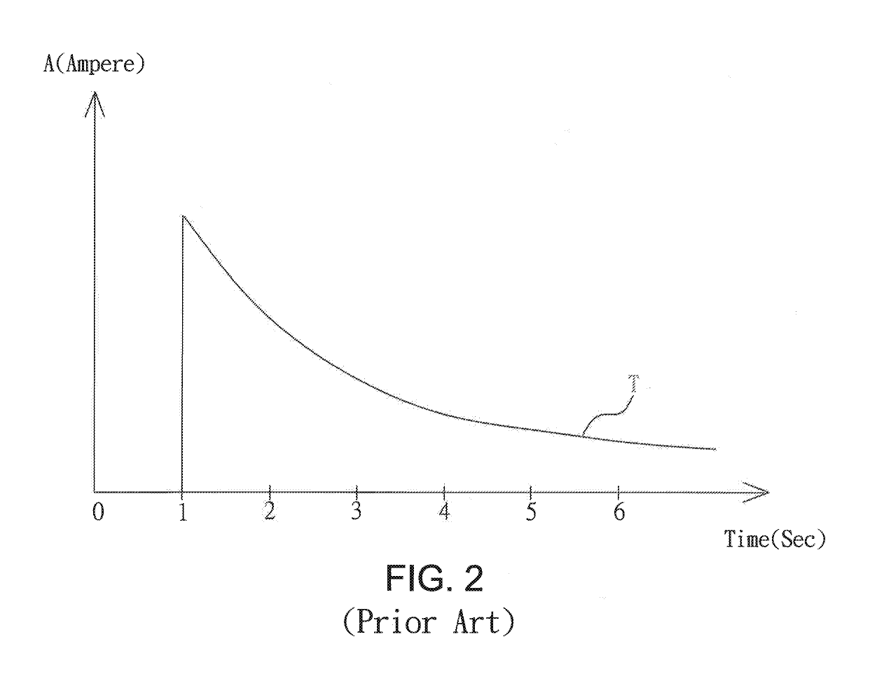

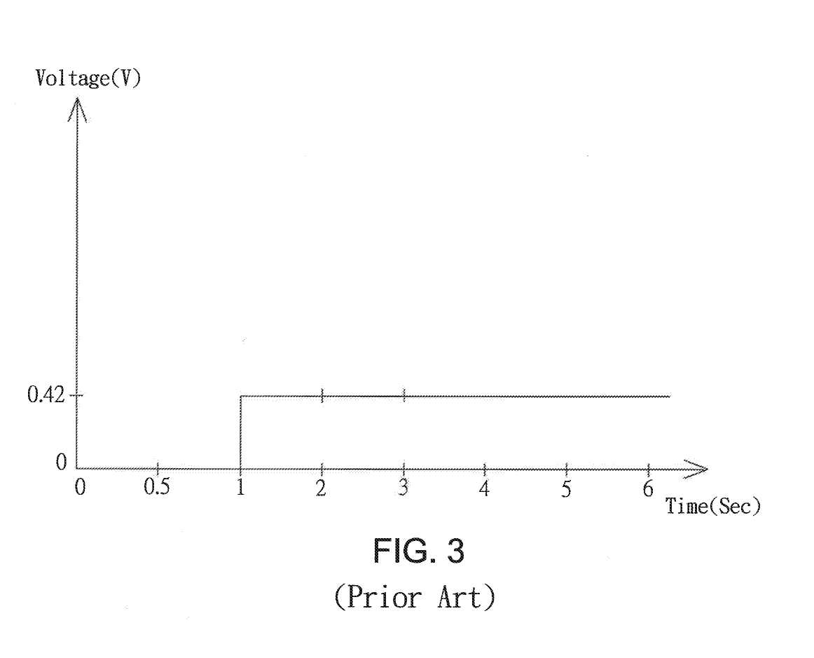

### DETAILED DESCRIPTION OF THE PREFERRED EMBODIMENTS

The technical measures and effects of the present disclosure are presented in preferred embodiments and accompanying drawings for descriptions of above purposes.

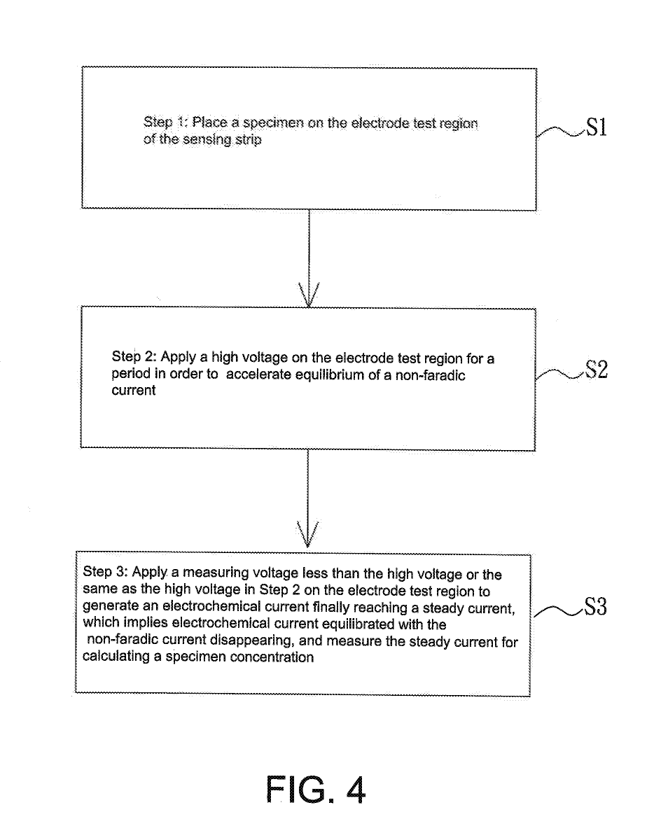

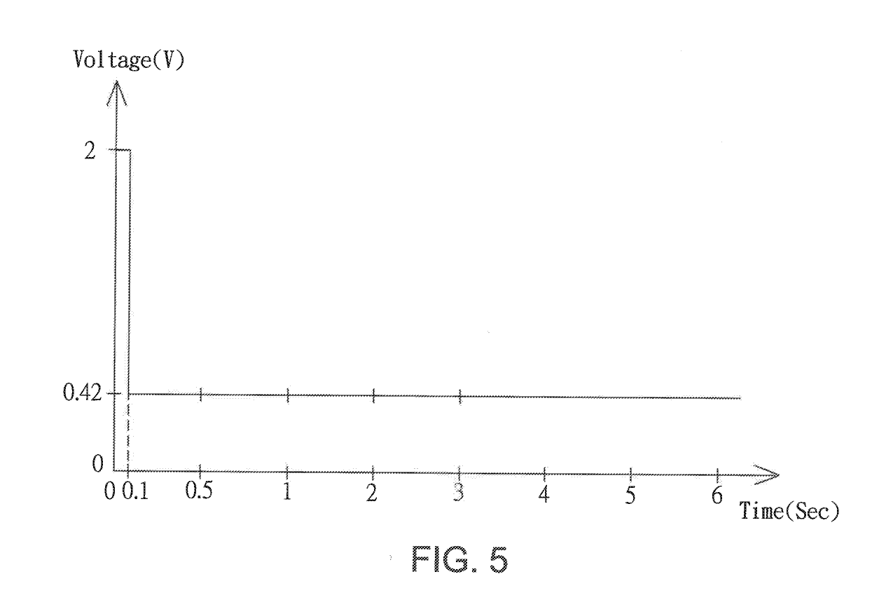

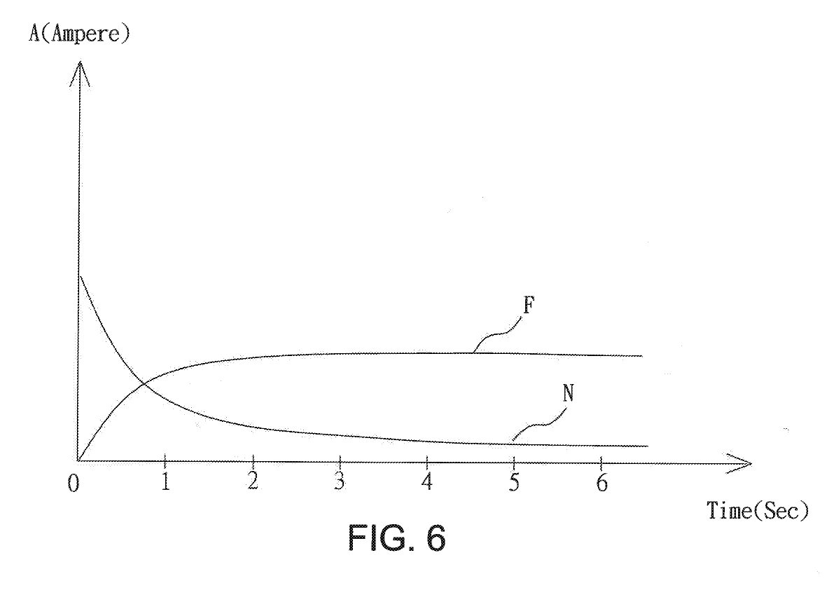

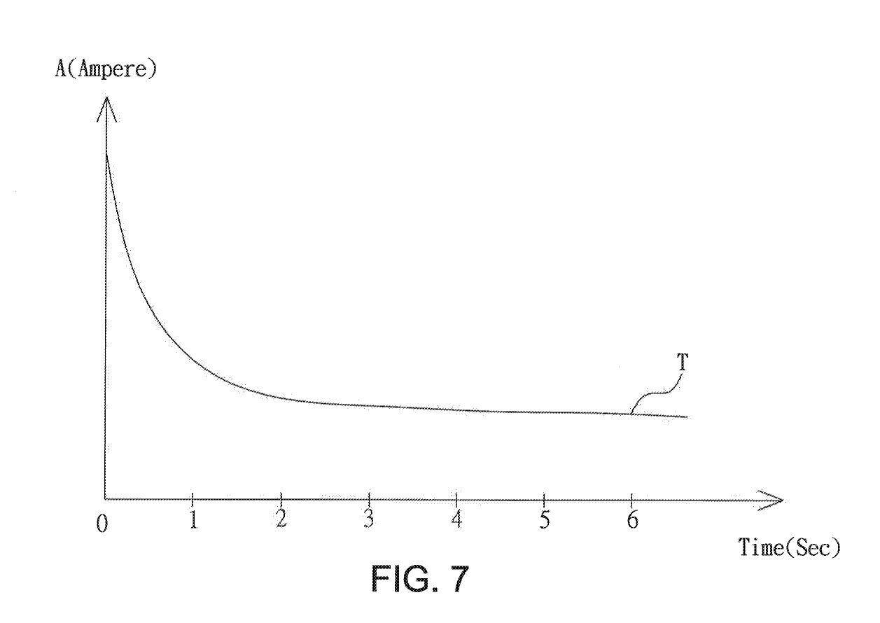

Please refer to FIG. 4 through FIG. 7: FIG. 4 is a flow diagram for the present disclosure of a method for fast measurement of a specimen concentration; FIG. 5 is a graph of voltages applied versus time in the present disclosure of a method for fast measurement of a specimen concentration; FIG. 6 is a graph of a faradic current and a non-faradic current versus time in the present disclosure of a method for fast measurement of a specimen concentration; FIG. 7 is a graph of a total current including faradic and non-faradic currents versus time in the present disclosure of a method for fast measurement of a specimen concentration.

As shown in the figures, the method for fast measurement of a specimen concentration needs at least a sensing strip (not shown in figures) with an electrode test region which includes, without limitation, a specific enzymatic reagent coating by referring to a specimen to be measured. For example, the enzymatic reagent can be glucose oxidase (urate oxidase or cholesterol oxidase) when a specimen is glucose (uric acid or cholesterol). No matter which ingredient is included in the reagent, the sensing strip is provided with an electrode test region on its surface. The present disclosure described with a specimen such as glucose herein includes, without limitation, a method for fast measurement of a specimen concentration comprises steps as follows:

Step 1: Place a specimen on the electrode test region of the sensing strip (S1);

Step 2: Apply a high voltage on the electrode test region for a period in order to accelerate equilibrium of a non-faradic current (as shown in FIG. 5 through FIG. 6) (S2); The high voltage is applied for a period from 0.01 to 1 second;

Step 3: Apply a measuring voltage less than the high voltage or the same as the high voltage in Step 2 on the electrode test region to generate an electrochemical current finally reaching a steady current, which implies electrochemical current equilibrated with the non-faradic current disappearing, and measure the steady current for calculating a specimen concentration (as shown in FIG. 5 and FIG. 7) (S3). Furthermore, the high voltage applied on the electrode test region for one period in Step 2 is to create electrochemical reactions therein by which at least a faradic current and at least a non-faradic current are generated. That is, the high voltage is intended to accelerate equilibrium (e.g., glucose) to be measured and a specific enzymatic reagent coated on the electrode test region (e.g., glucose oxidase (GOD for short)). The chemical equations are shown as follows:

Glucose+GOD₍ₒₓ₎->Gluconic acid+GOD_{(red)};

GOD_{(red)}+Med₍ₒₓ₎->GOD₍ₒₓ₎+Med₍ᵣₑ₎+2H⁺; and

2Med₍ᵣₑ₎->2Med₍ₒₓ₎+2e⁻

In the redox reactions, GOD_{(OX)}, the oxidation state of glucose oxidase (GOD) in normal status, reacts with glucose and is reduced to GOD_{(red)}, the reducing state. With electrons transferred to Mediator (Med₍ₒₓ₎) concurrently, Mediator (Med) is oxidized for generation of a reaction current, i.e., faradic current, F. However, other substance in the specimen such as uric acid or vitamin C, each of which interferes in a voltage applied on the electrode and induces a current, i.e., non-faradic current, N. In Step 2, the high voltage is intended to accelerate equilibrium of the reaction, consuming the non-faradic current quickly.

Including a faradic current and a non-faradic current initially, a total current generated in the electrode test region and finally becoming a steady current in Step 3 implies the electrochemical current equilibrated with non-faradic current disappearing. Therefore, the measured steady current is the faradic current, F, which is also known as Cottrell current and substituted into the following equation to calculate a specimen concentration.

i(t)=K·n·F·A·C·D^{0.5}·t^{-0.5}

where the definitions of all parameters are shown as follows. (a) i: measured instantaneous current or faradic current; (b) K: constant; (c) n: count of electrons transferred; (d) F: Faraday constant; (e) A: electrode test region's surface area; (f) C: specimen concentration; (g) D: reagent's diffusion coefficient; (h) t: time for a default voltage applied on the electrode test region. As mentioned above, a specimen concentration is calculated with the measured faradic current and other data substituted into the equation.

In the present disclosure, the high voltage applied in Step 2 for one period is kept between an oxidation potential and 5 Volt. As shown in FIG. 5, the oxidation potential in one embodiment is 2 Volt, the oxidation potential is the lower potential to create redox reactions on the specimen, that is, the high voltage should be responsible for redox reactions detected at the specimen and kept at 2 Volt preferably in the present disclosure because measured experimental data indicates a current induced by the high voltage (2 Volt) has a lower variance and is stable. Moreover, the high voltage should be constantly applied for one period from 0.01 second to 1 second. Preferably, the high voltage should be constantly applied for 0.1 second because measured experimental data indicates a current induced by the high voltage for 0.1 second has a lower variance and is stable. However, the specimen is electrolyzed unexpectedly and makes measurement inaccurate when the high voltage is either higher than 5 Volt or constantly applied for more than 1 second. In the present disclosure, the high voltage, which accelerates equilibrium of reactions and consumes the non-faradic current generated quickly, contributes to measurement effectively completed in 3 seconds or less than 3 seconds. That is, a total current including faradic and non-faradic currents generated at the electrode test region in Step 3 becomes a steady current in s short time, the short time is 3 seconds or below 3 seconds.

In the present disclosure, the measuring voltage which is less than the high voltage or the same as the high voltage in Step 2 and applied on the electrode test region in Step 3 initially should be kept at a normal level between 0.05 Volt and 0.42 Volt later.

Based on experimental data, the statistics presented hereinafter are used to explain the present disclosure is effective in keeping a steady current compared with a conventional method. In experiments, the glucose solutions were classified into three specimens with distinct concentration values, 50 mg/dl (specimen 1), 85 mg/dl (specimen 2) and 180 mg/dl (specimen 3), and tested in a conventional method as well as the method in the present disclosure. According to the conventional method, the three specimens were tested 5 times each for measurement of current values: no voltage applied from T=0 to T=1 sec. (time=0 to time=1 sec.); 0.42 Volt applied from T=1 sec to T=3 sec. According to the method of the present disclosure, the three specimens were tested 5 times each for measurement of current values: a high voltage of 2 Volt applied from T=0 to T=0.1 sec; a lower voltage of 0.42 Volt applied from T=0.1 sec to T=3 sec. The current values were measured at T=0.5 sec, T=1.0 sec, T=2.0 sec and T=3.0 sec in both types of experiments.

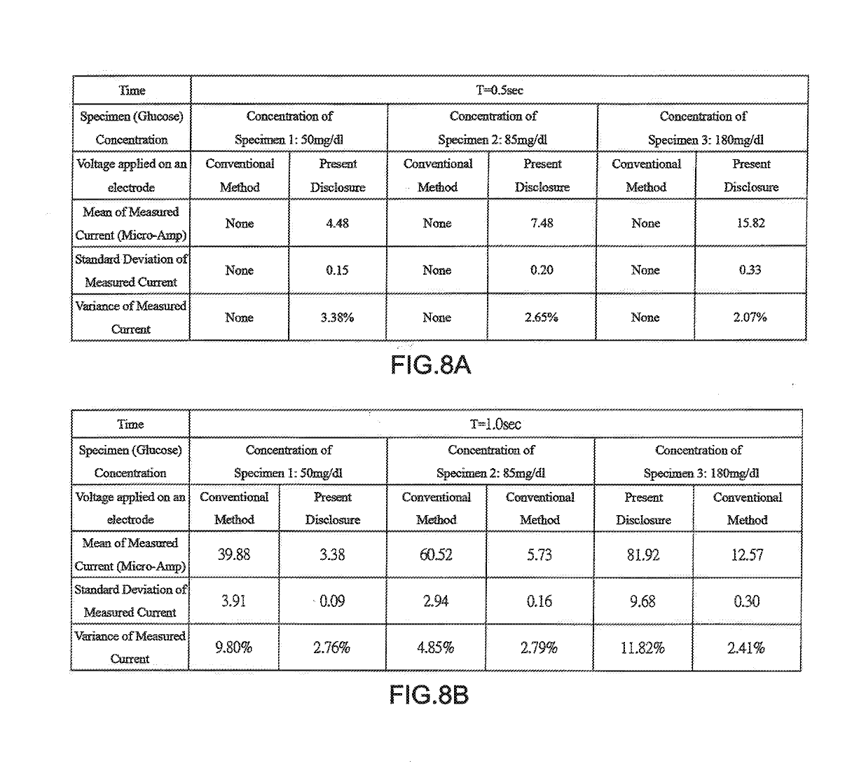

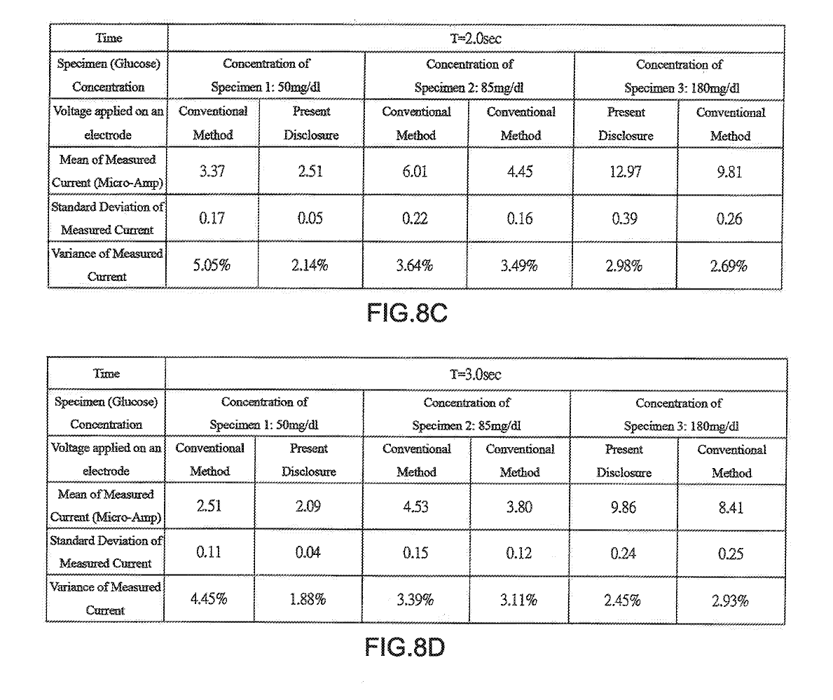

FIG. 8A illustrates data such as mean, standard deviation and variance for current values measured at T=0.5 sec; FIG. 8B illustrates data such as mean, standard deviation and variance for current values measured at T=1.0 sec; FIG. 8C illustrates data such as mean, standard deviation and variance for current values measured at T=2.0 sec; FIG. 8D illustrates data such as mean, standard deviation and variance for current values measured at T=3.0 sec. It can be seen from comparisons of variances for measured currents in FIGS. 8B, 8C and 8D that the method of the present disclosure contributes to a steady current and fast measurement of a specimen concentration in contrast to the conventional method due to low variances of currents measured at T=1.0 sec, T=2.0 sec or T=3.0 sec. Therefore, the present disclosure is beneficial to measurement of a specimen concentration completed in s short time by means of a high voltage applied for fast equilibrium of chemical reactions and fast termination of any reaction with non-faradic current.

The above descriptions are preferred embodiments which do not limit the scope of a method for fast measurement of a specimen concentration; any equivalent change or improvement without departing from spirit of the present disclosure should be incorporated in claims herein.

What is claimed is:

1. A method for fast measurement of a specimen concentration in a short time which needs at least a sensing strip with an electrode test region on which an enzymatic reagent with a specific ingredient is coated and comprises steps as follows:
Step 1: Place a specimen on the electrode test region of the sensing strip;
Step 2: Apply a high voltage on the electrode test region for a period in order to accelerate equilibrium of a non-faradic current;
Step 3: Apply a measuring voltage less than the high voltage or the same as the high voltage in Step 2 on the electrode test region to generate an electrochemical current finally reaching a steady current, which implies electrochemical current equilibrated with the non-faradic current disappearing, and measure the steady current for calculating a specimen concentration.

2. A method for fast measurement of a specimen concentration according to claim 1 wherein said high voltage in Step 2 is kept between the lowest potential to create oxidation reaction on the specimen and 5 Volt.

3. A method for fast measurement of a specimen concentration according to claim 1 wherein said high voltage in Step 2 is 2 Volt.

4. A method for fast measurement of a specimen concentration according to claim 1 wherein said high voltage in Step 2 is applied for a period from 0.01 second to 1 second.

5. A method for fast measurement of a specimen concentration according to claim 1 wherein said high voltage in Step 2 is applied for 0.1 second.

6. A method for fast measurement of a specimen concentration according to claim 1 wherein said measuring voltage in Step 3 is kept between 0.05 Volt and 0.42 Volt.

7. A method for fast measurement of a specimen concentration according to claim 1 wherein a total current including faradic current and non faradic currents generated on the electrode test region reaches a steady current in a short time to reach steady current, the short time is 3 seconds or below 3 seconds.

8. A method for fast measurement of a specimen concentration according to claim 1 wherein said specimen is glucose.

9. A method for fast measurement of a specimen concentration according to claim 1 wherein said specimen is uric acid.

10. A method for fast measurement of a specimen concentration according to claim 1 wherein said specimen is cholesterol.
